(19) United States
(12) Patent Application Publication
(10) Pub. No.: US 2014/0188773 A1
(43) Pub. Date: Jul. 3, 2014

(54) Empire of the Future

(71) Applicant: Anuthep Benja-Athon, New York, NY (US)

(72) Inventor: Anuthep Benja-Athon, New York, NY (US)

(21) Appl. No.: 13/730,882

(22) Filed: Dec. 29, 2012

(51) Int. Cl. G06N 5/02

(52) U.S. Cl. CPC G06N 5/02
USPC 706/46

(57) ABSTRACT

A scientific system for molding and controlling individuals' and people's future and destinies through networks of devices and servers. The system having a repertoire of knowledge and intelligence, a system intellection and foresight for applying requests for prognostications and foretells in individuals' and people's future and destinies referencing to past, current and future chronicles in the repertoire to generate prognostications and foretells and networks for disseminating and sharing the prognostications and foretells for molding and controlling future and destinies.

### FIELD OF THE INVENTION

A scientific system for molding and controlling individuals' and people's future and fates through networks.

### BACKGROUND OF THE INVENTION

Since first man walked the earth, every human has constant and must-have needs to know about and attempt to influence and control the future and destiny to achieve life-and-death, physical and mental well-beings, securities, longevity and productivity, etc. Future and destinies are enigmatic universe dimensions and phenomena of the universe in which humans can neither heretofore manage, modify, mold, control and share. All people thrive on luck and skills to be productive and successful. Individuals must guess future with immense diverse and often undesirable and irreversible consequences.

The present invention, however, provides billions of people—individuals and groups of people—with the best scientific means, methods and know-how for modifying, managing, sharing, molding and controlling individuals' and people's future and destinies, fates and karmas pertaining and relating to physical and biological causalities, events, matters, issues, occurrences, phenomena, etc. of and in people's lives. The present invention transforms billions of random events and processes daily into precise, guided and planned events and processes to achieve targeted, desired and forecasted or predictable objectives and consequences in people's lives. The present invention provides one of most unique skills for individuals and people in diverse places to have better or the best perceptions, grasps, impressions and comprehension of events and courses of lives as verbally forewarned, admonished and advised by other people such as, parents and wise people and to accordingly behave and undertake processes to modify, adapt and mold their future and destinies. Therefore, billions of young, inexperience, naive and/or unguided people—in fact, all people—will have better lives and future. The famous phrase “hindsight is 20 20” will be fortuitously replaced by “foresight is 20 20”. The diverse consequences and benefits are infinite for people, societies and humanity.

### SUMMARY OF THE INVENTION

Despite millennia-old method of admonishing and improvements in communications for billions of people by telephones, computers, Internet and mobile communication devices, all people and civilization heretofore remained in the same predicament of awaiting fates to befall them as people in the past millenniums.

The present invention provides a technology for advancing all living people and civilizations into the future. Realistically, better and more powerful than the Oracle at Delphi, the technology provides a scientific system which is responsive to any and all people who can access this omnipotent and omnipresent system on the planet.

By using this scientific and real system for scientifically prognosticating and foretelling individuals' and people's future and destinies through networks of devices and servers having a Big Data serving as an immense repertoire and wealth of relational data on knowledge, memories, lessons, experiences, and intelligence of civilizations and an intelligent system intellection and foresight for intelligently applying said repertoire to generate, visually and auditory display, maintain, monitor and adapt trends comprising prognostications and foretells of future and destinies with references to past, current and future chronicles on demands by any and all individuals and people. People, societies and civilizations are forever transformed and advanced into future by the present invention.

### DESCRIPTION OF THE PREFERRED EMBODIMENTS

The present invention provides a system and method for molding and controlling individuals' and people's future (plural) and destinies through networks of servers and devices by creating and implementing an intelligent system intellection and foresight in said networks. Consequently, the present invention shapes and controls individuals' and people's future and destinies by generating trends comprising prognostications and foretells and sequences and algorithms of prognostications and foretells in conjunction with past, current and future chronicles in individuals' lives, people's lives, histories and civilizations in said networks based on input instances having attached past and current chronicles in individuals' lives generated by said networked devices. When generated, said trends are disseminated in and among said selected networked servers and devices in said networks. Furthermore, said disseminated trends including the contents can be adapted, changed, adjusted, altered and replaced in and among said selected networked servers and devices.

The present invention provides networks of servers including virtual servers located in world-wide data centers and desktops, computer tablets, mobile communication devices including, but not limited to, tablets, cellular phone and smartphones each of which having one or plurality of touchscreens including liquid-crystal-display touchscreens and teleconferencing platforms henceforth devices. Said servers and devices having processor units coupled to system storage including cloud-based storage by said network capabilities. Said network capabilities and many common commercial technologies for transmitting such as, but not limited to, streaming, pushing, pulling and sharing trends to and among servers and individual devices and groups of devices identified by said servers for generating said trends to receive, adapt, change and adjust and alter or replace trends. Said network capabilities and many common commercial technologies for maintaining and monitoring trends in said networks are applied by the present invention.

One of the preferred embodiments of the present invention, said intelligent system intellection and foresight comprising innovative computer programs and software coupled to servers processor units, Big Data including structured and unstructured databases in said system storage or repository including cloud-based storage in said networks of servers and devices, at least one enterprise search technology for searching Big Data being assisted by at least one web search technology for searching structured and unstructured databases in the World Wide Web, and data analytics and statistics analytics and commercial computer programs for enhancing said system intellection and foresight for managing and applying relational data and inherent abstracts, concepts and logics in said Big Data, searched relational data, input instances and related past and current chronicles.

Said system intellection and foresight created Big Data comprising trillion gigabytes or zettabytes of compilations of relational data on past, current and future chronicles in individuals' and people's lives, histories and civilizations. Said compilations are derived from past, current and future chronicles in individuals' and people's lives, histories and civilizations input into said networked servers and also from inputs including input instances described herein by devices being used by people. Said compilations comprise, first, explicit relational data on individuals' and people's lives, histories and civilizations comprising causalities, causes, milestones, events, occurrences, processes, properties, facts, genotypes, phenotypes, genetics and genetic codes, consequences, sequelae, places, time, chronologies, variables, input instances and related trends and any combinations thereof having attached outcomes of statistical analyses. Second, in said Big Data, said system intellection and foresight intelligently created implicit relations of said relations and related logics, implications, deductions and inferences having attached outcomes of statistical analyses. Third, said intelligent system intellection and foresight further intelligently created analogies of said relations and related logics, implications, deductions and inference having attached outcomes of statistical analyses. To grow the present invention, fourth, said intelligent system intellection and foresight intelligently created permutations in and among said explicit, implicit relations and analogies and related logics, implications, deductions and inferences having attached outcomes of statistical analyses, extrapolations of said relations and permutations and related logics, implications, deductions and inferences having attached outcomes of statistical analyses; and said relations and extrapolations and permutation of said relations and related logics, implications, deductions, inferences, determinations and conclusions having attached outcomes of statistical analyses.

To be omnipotent, fifth, said system intellection and foresight and system storage structured said relational data and by virtue of said expanding multi-dimensional relations of relational data in said Big Data, said relational data inherently derived and possessed abstracts, concepts and logics, implications, deductions, inferences, determinations and conclusions inherent in individuals' and people's lives, histories and civilizations and said relational data. One of the preferred embodiments, said relations incorporate or possess inherent abstracts, concepts and logics, implications, deductions, inferences, determinations and conclusions in said relational data in said Big Data. Another preferred embodiment is to generate said relations related to relations comprising inherent abstracts, concepts and logics, implications, deductions, inferences, determinations and conclusions in said relational data in said Big Data. Other preferred embodiments including using commercial computer programs for enhancing said system intellection and foresight for managing and applying relational data having inherent abstracts, concepts and logics, implications, deductions, inferences, determinations and conclusions in input instances and relational data in said Big Data will be used. Moreover, said system intellection and foresight possessing knowledge, experiences, intelligence, lessons, know-how, insights and foresight to apply said input instances, relational data and related abstracts, concepts and logics, implications, deductions, inferences, determinations and conclusions to generate trends for molding and controlling individuals' and people's future and destinies through said networks.

To achieve said objectives and goals of the present invention, said system intellection and foresight can apply various types of enterprise search technologies represented by, but not limited to, Autonomy which is owned by Hewlett-Packard Co. and those of other well-known technology corporations such as, but not limited to, IBM. One of the preferred embodiments of the present invention is the applications of enterprise search technologies to search data in said Big Data in said system storage as described infra whenever input instances are generated and submitted to said system intellection and foresight by said networked devices and/or servers.

Billions of devices in said networks can generate input instances in said networks of servers and devices. Said input instances comprise causalities, causes, milestones, events, occurrences, processes, properties, facts, genotypes, phenotypes, genetics and genetic codes, consequences, sequelae, places, time, chronologies and/or variables, etc. and any combinations thereof. Said input instances may or may not attaching past and current chronicles in individuals' lives and related abstracts, concepts, logics, meanings and/or implications.

The following represents one of the preferred embodiments of the present invention:

In one of the preferred embodiments, input instances are generated by networked devices and submitted to networked servers wherein said system intellection and foresight having knowledge, experiences, intelligence, logics, know-how and foresight, referencing to said relational data in Big Data, analyzes the inherent abstracts, concepts, logics, meanings and implications in sequences of data in said input instances and attached past and current chronicles in the lives of users of said devices. For example, the products of said analyses are such as, but not limited to, categorization or organization of elements and sequences and algorithms of said elements in said abstracts, concepts, logics, meanings and implications which enable and facilitate enterprise search technology to search relational data in Big Data based on said categorization and organization. Said categorization or organization can also be facilitated and achieved by said devices inputting categories and organizations of chronicles in said past and current chronicles to said servers. Based on said intelligent analyses, said system intellection and foresight specifies and instructs said enterprise search technology to apply the products of said analyses to search said relational data in compilations in said Big Data for related past, current and future chronicles possessing same, similar or analogous abstracts, concepts, logics, meanings and/or implications as abstracts, concepts, logics meanings and/or implications inherent in said past and current chronicles attaching to input instances and said input instances having same, similar or analogous abstracts, concepts, logics, meanings and/or implications as said future chronicles in said relations. Having searched said relational data, system intellection and foresight apply statistics analytics to said searched relational data comprising past, current and future chronicles and attached abstracts, concepts, logics, meanings and/or implications related to said input instances and attached past and current chronicles and attached abstracts, concepts, logics, meanings and/or implications to determine good degrees of statistical matches or fits among said abstracts, concepts, logics, meanings and implications and related past, current chronicles and sequences in said input instances to said searched relational data and assigning good degrees of statistical matches or fits to said matches or fits. And, accordingly, said system intellection and foresight selects said past, current and future chronicles to generate trends comprising sequences or algorithms of said past, current and future chronicles representing system intellection and foresight-generated prognostications and foretells and sequences and algorithms of prognostications and foretells of individuals' future and destinies.

In another preferred embodiment, input instances are generated by networked devices and submitted to networked servers wherein said system intellection and foresight analyzes sequences and/or algorithms of chronicles in said past and current chronicles in the lives of users of said devices attached to said input instances inputted by said devices. For example, the products of said analyses are such as, but not limited to, categorization or organization of sequences and/or algorithms of chronicles in said past and current chronicles and sequences of data in related input instances. Said categorization or organization can also be facilitated and achieved by said devices inputting categories and organizations of chronicles in said past and current chronicles to said servers. Based on said intelligent analyses, said system intellection and foresight specify and instruct said enterprise search technology to search for relations of chronicles in individuals' and people's lives, histories and civilizations in said relational data in said Big Data as same, similar or analogous sequences and/or algorithms of chronicles in said past and current chronicles and attached sequences in said input instances. Said enterprise search technology to search for relations in future chronicles same, similar or analogous to said sequences in said input instances in explicit relations, implicit relations of said relations and related abstracts, concepts, logics, meanings, implications, deductions, inferences, determinations and conclusions; analogies of said relations and related abstracts, concepts, logics, meanings, implications, deductions, inferences, determinations and conclusions; permutations in and among said explicit, implicit relations and analogies and related abstracts, concepts, logics, meanings, implications, deductions, inferences, determinations and conclusions; extrapolations of said relations and permutations and related abstracts, concepts, logics, meanings, implications, deductions, inferences, determinations and conclusions; and said relations and extrapolations and permutation of said relations and related abstracts, concepts, logics, meanings, implications, deductions, inferences, determinations, conclusions, determinations and conclusions in said Big Data.

In said search, abstracts, concepts, logics, meanings and implications in said relational data and past and current chronicles in the lives of users of said devices and attached input instances may be considered. Having searched said relational data, said processes in said preferred embodiment are executed herein.

In yet another preferred embodiment, the present invention can and will use any and all combinations of said processes to achieve the goals and objectives of the present invention.

Furthermore, in said preferred embodiments, said system intellection and foresight specify and instruct said enterprise search technology to search explicit and implicit relations of said relations and related abstracts, concepts, logics, meanings, implications, deductions, inferences, determinations and conclusions; analogies of said relations and related abstracts, concepts, logics, meanings, implications, deductions, inferences, determinations and conclusions; permutations in and among said explicit, implicit relations and analogies and related abstracts, concepts, logics, meanings, implications, deductions, inferences, determinations and conclusions; extrapolations of said relations and permutations and related abstracts, concepts, logics, meanings, implications, deductions, inferences, determinations and conclusions; and said relations and extrapolations and permutation of said relations and related abstracts, concepts, logics, meanings, implications, deductions, inferences, determinations, conclusions, determinations and conclusions in said Big Data.

Furthermore, in said preferred embodiments, said system intellection and foresight can specify and instruct said web search technology to search World Wide Web data to complement said searched relational data if outcomes of said data analyses and statistics analyses produced unacceptable or not good statistical matches or fits. Furthermore, said system intellection and foresight can generate queries or requests to networked devices to generate additional input instances if outcomes of said data analyses and statistics analyses produced unacceptable statistical matches or fits.

Said processed input instance and related products of said processes are merged with relational data in said compilations to expand and improve relational data and inherent abstracts, concepts, logics, meanings, implications, deductions, inferences, determinations, conclusions, determinations and conclusions in said Big Data.

Said trends comprise prognostications and foretells and sequences and algorithms of prognostications and foretells of individuals' and people's future and destinies. Said prognostications and foretells comprising sequences and algorithms of causalities, milestones, events, occurrences, processes, properties, facts, matters, genotypes, phenotypes, genetics and genetic codes, outcomes, consequences, sequelae and related variables and any combinations thereof, said relations referencing places, time, chronologies and having attached outcomes of statistical analyses.

Said prognostications and foretells and sequences and algorithms of prognostications and foretells in a trend are maintained, monitored in said networks. Said prognostications and foretells and/or sequences and/or algorithms of prognostications and foretells in a trend can be adapt or alter in said networks by an input instance being generated in said networks said processes as described supra.

System network capabilities disseminate, stream and share said trends including adaptations, changes and adjustments or alterations or replacements of trends having attached outcomes of statistical analyses among networked servers and devices.

According to said preferred embodiment, there are billions to trillions of trends and related adaptions to be generated and disseminated in and among said networked servers and devices by input instances generated in millions to billions of networked devices. Said input instances and trends are inputted into and stored in said system storage in said networked servers and devices.

As an example of said preferred embodiments, a wise professor recently opined—in this context, representing an input instance generated by said devices of the present invention—“for more than a century, the U.S. economy grew robustly thanks to big inventions; those days are gone” in a writing entitled “Why Innovation Won't Save Us” and attached past and current chronicles “the invention of light bulb in 1879, power station, typewriters, computer revolution to the Internet, e-retailers, search engines to 1990's”.

By applying said “for more than a century, the U.S. economy grew robustly thanks to big inventions, those days are gone, Why Innovation Won't Save Us” as a representation of an input instance—with or without attaching past and current chronicles in individuals' lives including said professor—said system intellection and foresight analyzes the inherent abstracts, concepts, logics, meanings and implications in sequences of data in said input instances comprising said “for more than a century, the U.S. economy grew robustly thanks to big inventions, those days are gone, Why Innovation Won't Save Us”—with attached past and current chronicles which are “attached past and current chronicles “the invention of light bulb in 1879, power station, typewriters, computer revolution to the Internet, e-retailers, search engines to 1990's”. As an example, the products of said analyses are such as, but not limited to, abstracts, concepts, logics, meanings and implications in the categorization or organization of sequences of technologies comprising electricity, computer and mobile computer, networking, search technology, e-commerce which enable and facilitate enterprise search technology to search relational data in Big Data based on said categorization and organization.

Based on said intelligent analyses, said system intellection and foresight specify and instruct said enterprise search technology to apply the products of said analyses to search relational data in compilations in said Big Data for related past, current and future chronicles possessing same, similar or analogous abstracts, concepts, logics, meanings and/or implications as abstracts, concepts, logics meanings and/or implications inherent in said past and current chronicles attaching to input instances and said input instances having same, similar or analogous abstracts, concepts, logics, meanings and/or implications as said future chronicles in said relations. Having searched said relational data, system intellection and foresight apply statistics analytics to said searched relational data comprising past, current and future chronicles and attached abstracts, concepts, logics, meanings and/or implications related to said input instances and attached past and current chronicles and attached abstracts, concepts, logics, meanings and/or implications to determine good degrees of statistical matches or fits among said abstracts, concepts, logics, meanings and implications and related past, current chronicles and sequences in said input instances to said searched relational data and assigning good degrees of statistical matches or fits to said matches or fits and, accordingly, said system intellection and foresight select said past, current and future chronicles to generate trends comprising sequences or algorithms of said past, current and future chronicles representing system intellection and foresight-generated prognostications and foretells and sequences and algorithms of prognostications and foretells of individuals' future and destinies.

Consequently, based on and consequent to supra, said system intellection and foresight would have generated searched relational data from said relational data and selected past, current and future chronicles in individuals' lives and histories in technologies specifically in the time between 1879-2020—with good statistical matches or fits of said inherent abstracts, concepts, logics, meanings and/or implications in said input instance as same, similar or analogous abstracts, concepts, logics meanings and/or implications inherent in said searched relational data comprising past, current and future chronicles in individuals' lives and histories in hardware and software technologies specifically in the time between 1700's-2020 with good degrees of statistical fits to generate inferences, decisions, determinations and conclusions having attached outcomes of statistical analyses to generate at least one trend in the devices being used by said professor and among other devices. This trend will chronicle the past and current chronicles comprising a sequence of Benjamin Franklin's kite, lightning, atmospheric electricity, electricity, electric current, innovations of light bulb in 1879, power station, typewriters, computer revolution to the Internet, e-retailers, search engines to 1990's, enterprise-social networking, smart machines, buildings and environments . . . and future chronicles comprising numerous domestic and global e-commerce, global platforms such as, but not limited to, electronic trading platforms of the 12-year-old Intercontinental Exchange superseding the floor trading of the NYSE-Euronext, an innovative Global Super Store technology for global commerce, trades and transactions of goods and services circling the planet and the present invention for evolving societies and civilizations with significantly immense outcomes and consequences for individuals' and people's future and destinies and, consequently, humanity.

Furthermore, as described supra, said system intellection and foresight specify and instruct said enterprise search technology to search explicit and implicit relations of said relations and related abstracts, concepts, logics, meanings, implications, deductions, inferences, determinations and conclusions; analogies of said relations and related abstracts, concepts, logics, meanings, implications, deductions, inferences, determinations and conclusions; permutations in and among said explicit, implicit relations and analogies and related abstracts, concepts, logics, meanings, implications, deductions, inferences, determinations and conclusions; extrapolations of said relations and permutations and related abstracts, concepts, logics, meanings, implications, deductions, inferences, determinations and conclusions; and said relations and extrapolations and permutation of said relations and related abstracts, concepts, logics, meanings, implications, deductions, inferences, determinations, conclusions, determinations and conclusions in said Big Data.

In brief, because of said structure of said relations in said relational data and inherent abstracts, concepts, logics, meanings, implications, deductions, inferences, determinations and conclusions in Big Data and said intelligent system intellection and foresight having knowledge, experiences, intelligence, logics, know-how and foresight to analyze said input instance—representing input instances—said future chronicles depicting future and destinies of people being involved and served by yet another generation of technologies stemming from global enterprise-social networking of people generated from said relational data in contradiction to abstracts, concepts, logics, meanings, implications in said professor's input instance “ . . . , Why Innovation Won't Save Us”. Furthermore, without referencing to past and current chronicles, parents and wise people can forewarn and advise their children and audience to accordingly behave, pursue and undertake processes to accordingly modify, adapt and mold their educations, careers, endeavors, enterprises, future and destinies.

Said future chronicles are prognostications and foretells comprising sequences and algorithms of future chronicles comprising sequences and algorithms causalities, milestones, events, occurrences, processes, properties, facts, matters, genotypes, phenotypes, genetics and genetic codes, outcomes, consequences, sequelae and related variables and any combinations thereof, said sequences and algorithms referencing places, time, chronologies and having outcomes of statistical analyses. Furthermore, said future chronicles can be displayed as documents, documentaries, Web pages, websites to visit, digital presentations, videos, movies, voice data, phone conversations, tweets, email, compilations of digital contents and any combinations thereof which will enable. individuals and people in diverse places to have better or the best perceptions, grasp and apprehensions of their future in their lives, future as being told and described to them by other people including parents and the wise people and to modify, adapt and mold their future and destinies.

Furthermore, said system intellection and foresight can specify and instruct said web search technology to search World Wide Web data to complement said searched relational data if outcomes of said data analyses and statistics analyses produced unacceptable or not good statistical matches or fits. Furthermore, said system intellection and foresight can generate queries or requests to networked devices to generate additional input instances if outcomes of said data analyses and statistics analyses produced unacceptable statistical matches or fits. For example, said professor might not have provided said attached past and current chronicles “the invention of light bulb in 1879, power station, typewriters, computer revolution to the Internet, e-retailers, search engines to 1990's” and, therefore, said web search technology to search World Wide Web data could have search World Wide Web data and/or request from said professor said input.

In brief, therefore, if the present invention was available to the wise professor several weeks ago, he would have generated at least one input instance represented by said explicit relation in his networked devices. By said input instance attached to past and current chronicles being generated in networked devices and submitted to said servers comprising said system intellection and foresight, consequently, people including said professor would have engaged said representative trend which will precisely mold and control people's including said professor's future and destinies as described supra. Furthermore, without referencing to past and current chronicles, parents and wise people can forewarn and advise their children and audience to accordingly behave, pursue and undertake processes to accordingly modify, adapt and mold their educations, careers, endeavors, enterprises, future and destinies.

Another example of another preferred embodiments of the present invention, a representative explicit relation in said immense relational data on American history on transportation in the 16^{th}-21^{th} century and how it developed and shaped the present U.S.A. In brief, a relational past and current chronicles mid to late 19^{th} century America, Cornelius Vanderbilt, boat, commercial ships, railroads, railroad strategies and logistics, stock market, . . . Grand Central Station, Manhattan, John D. Rockefeller, crude oil, kerosene, pipelines, Andrew Carnegie, Ohio Telegraphy Company, British smelter, Eads bridge, Mississippi River, Carnegie Steel Company, steel-frame buildings, John Pierpont Morgan, . . . United States Steel Corporation . . . nanotechnology . . . interplanetary space stations . . . .

Using the present invention based on said past, current and future chronicles and related as identified in said first embodiment, space entrepreneurs will have generated input instances such as, but not limited to, “interplanetary transport of planetary resources between earth and moon”. Based on said processes represented supra in said preferred embodiment, said intelligent system intellection and foresight will generate searched relational data from said Big Data to generate at least a trend of prognostications and foretells and sequences and algorithms of prognostications and foretells—future chronicles—comprising at least nanotechnology, alloys, pipelines, manufacturing processes, space engineering know-how, planetary sites and locations, economics and finances, direct and indirect collateral consequences on earth and moon environments, geography and tides and weather patterns and, etc. to achieve the objectives and goals of the present invention.

Furthermore, in said preferred embodiments, said system intellection and foresight can specify and instruct said web search technology to search World Wide Web data to complement said searched relational data if outcomes of said data analyses and statistics analyses produced unacceptable or not good statistical matches or fits. Furthermore, said system intellection and foresight can generate queries or requests to networked devices to generate additional input instances if outcomes of said data analyses and statistics analyses produced unacceptable statistical matches or fits.

The system of the present invention has server operating system, SQL Server and MySQL and the like, computer scripting languages, html, various commercially available hardware including, but not limited to, routers, switches, modems and wireless and cable telecommunications devices.

The present invention using commercial network capabilities for networking servers including virtual servers—made popular by VMware, Inc. of EMC Corp.—with desktops, computer tablets, mobile communication devices including, but not limited to, tablets, cellular phone and smartphones and teleconferencing platforms. Said teleconferencing platforms are enabled by the likes of www.webex.com by Cisco Systems, Inc. and www2.gotomeeting.com by Citrix Online, L.L.C. and the derivatives. Stream, push, pull, file share technologies using commercially available program and software, such as, but not limited to, the Comet technology being sold by several companies such as, LightStreamer and Skype of Microsoft Skype Division and the like and their derivatives and related for disseminating, propagating and sharing said data and trends including real-time information and data as described in the preferred embodiments of the present invention. Numerous enterprise and social networkings will also be used to achieve the goals and objectives of the present invention.

Although said representative preferred embodiments have been described, it will be appreciated by those skilled in the art that adaptations, variations and derivatives are and will be made and achieved without departing from the spirit and the scope of the claims of the present invention.

Although various preferred embodiments of the present invention have been described, it will be appreciated by those skilled in the art that adaptations, variations and derivatives are and will be made and achieved for individuals' and people's decisions and actions in locomotion and driving involving GPS, flights and endeavors and enterprises such as, but not limited to, purchases and transactions of goods and services, starting or launching and executing businesses, enterprises and endeavors without departing from the spirit and the scope of the claims of the present invention.

Although various preferred embodiments of the present invention have been described, it will be appreciated by those skilled in the art that adaptations, variations and derivatives are and will be made and achieved without departing from the spirit and the scope of the claims of the present invention.

1. A system for molding and controlling individuals' and people's future and destinies through networks of servers and devices, said system having system intellection and foresight for generating, maintaining, monitoring and adapting trends for molding said future and destinies based on system intellection and foresight processing input instances in conjunction with past and current chronicles possessing inherent abstracts, concepts, logics, meanings and implications in individuals' lives with relational data comprising past, current and future chronicles possessing inherent abstracts, concepts, logics, meanings and implications in individuals' and people's lives, histories and civilizations, said system intellection and foresight for generating, maintaining, monitoring and adapting trends for molding and controlling said future and destinies in said networks, said system having networking capabilities and technologies for transmitting trends in said networks, said system comprising:
said system intellection and foresight comprising innovative computer programs and software coupled to servers processor units, said Big Data and structured and unstructured databases in said system storage in said networks, at least one enterprise search technology for searching said Big Data and data and at least one web search technology for searching data in the World Wide Web, and data analytics and statistics analytics of input instances and searched relational data and commercial computer programs for enhancing said system intellection and foresight for managing and applying relational data having inherent abstracts, concepts, logics, meanings and implications in said input instances, Big Data and data;
said system intellection and foresight for specifying and compiling said relational data including processed input instances in conjunction with past, current and future chronicles in individuals' lives, histories and civilizations, related abstracts, concepts, logics, meanings and implications, inferences, decisions, determinations and conclusions and outcomes of statistical analyses, related trends and outcomes of statistical analyses, for processing input instances by applying data analytics and statistics analytics to said input instances in conjunction with past and current chronicles in individual lives of users of devices and specifying how search technologies search said Big data and data and for applying data analytics and statistics analytics to said processed input instances and searched relational data to generate inferences, decisions, determinations and conclusions having attached outcomes of statistical analyses to generate, maintain, monitor and adapt or alter trends in said networks, for learning, acquiring and applying knowledge, experiences, intelligence, logics, foresight and insights for analyzing and processing said input instances with relational data and searched relational data to generate trends;
Big Data in system storage coupled to system intellection and foresight, said Big data comprising compilations of said relational data on past, current and future chronicles in individuals' and people's lives, histories and civilizations having inherent abstracts, concepts, logics, meanings and implications, inferences, decisions, determinations and conclusions in individuals' and people's lives, histories and civilizations, said compilations including system intellection and foresight-processed input instances attaching past, current and future chronicles, related searched relations and searched relational data and data, and related abstracts, concepts, logics, meanings and implications, inferences, decisions, determinations and conclusions, related trends and outcomes of statistical analyses, said compilations are system repertoire of relational data having inherent abstracts, concepts, logics, meanings and implications, inferences, decisions, determinations and conclusions for specifying how system intellection and foresight and input stances define trends;
input instances generated by said networked servers and devices, said input instances in conjunction with past and current chronicles possessing inherent abstracts, concepts, logics, meanings and implications define said searched relational data and trends in said networks, said input instances are relational elements in future chronicles in said relational data and searched relational data in said networks, said input instances in conjunction with past, current and future chronicles possessing inherent abstracts, concepts, logics, meanings and implications define relational data in said Big Data; and
said system comprising networks of servers including virtual servers located in world-wide data centers and said devices comprising desktops, computer laptops and tablets, mobile communication devices and teleconferencing platforms, said servers and devices having processor units coupled to system storage including cloud-based storage by said network capabilities, said network capabilities and technologies for transmitting and disseminating trends to and monitoring and adapting and altering trends in individual devices and groups of devices in said networks.

2. The system according to claim 1 wherein said innovative computer programs and software coupled to servers processor units comprise codes and programs for specifying and instructing said system intellection and foresight how to apply data analytics and statistics analytics to input instances in conjunction with past and current chronicles in individuals' lives and searched relational data to:
create, improve and expand said compilations in said Big Data;
process said input instances in conjunction with past and current chronicles in individuals' lives with searched relational data and data to trends having outcomes of statistical analyses, said compilations;
compile and structure relational data including processed input instances in conjunction with past, current and future chronicles in individuals' lives, histories and civilizations and related trends having inherent abstracts, concepts, logics, meanings and implications and outcomes of statistical analyses.

3. The system according to claim 1 wherein said past, current and future chronicles in individuals' and people's lives, histories and civilizations comprise sequences and algorithms of causalities, causes, milestones, events, occurrences, processes, properties, facts, genotypes, phenotypes, genetics and genetic codes, consequences, sequelae and/or variables and any combinations thereof relating to places, time and chronologies possessing inherent abstracts, concepts, logics, meanings and implications, deductions, inferences, determinations and conclusions.

4. The system according to claim 1 wherein said input instances comprise causalities, causes, milestones, events, occurrences, processes, properties, facts, genotypes, phenotypes, genetics and genetic codes, consequences, sequelae, places, time, chronologies and/or variables and any combinations thereof having inherent abstracts, concepts, logics, meanings and implications, said input instances are generated by said networked devices.

5. The system according to claim 1 wherein said relational data in said Big Data comprise:
explicit relational data on chronicles in past, current and future individuals' lives, and people's lives, histories and civilizations and related logics, implications, deductions and inferences having attached outcomes of statistical analyses;
implicit relations of said relations and related logics, implications, deductions and inferences having attached outcomes of statistical analyses;
analogies of said relations and related logics, implications, deductions and inference having attached outcomes of statistical analyses;
permutations in and among said explicit, implicit relations and analogies and related logics, implications, deductions and inferences having attached outcomes of statistical analyses;
extrapolations of said relations and permutations and related logics, implications, deductions and inferences having attached outcomes of statistical analyses; and
said relations and extrapolations and permutation of said relations and related abstracts, concepts, logics, meanings and implications, deductions, inferences, determinations and conclusions having attached outcomes of statistical analyses.

6. The system according to claim 1 wherein said World Wide Web data comprising documents, documentaries, Web pages, Websites, digital presentations, videos, movies, voice data, phone conversations, tweets, email, compilations of digital contents and any combinations thereof.

7. The system according to claim 1 wherein said prognostications and foretells are sequences and algorithms of future chronicles comprising sequences and algorithms causalities, milestones, events, occurrences, processes, properties, facts, matters, genotypes, phenotypes, genetics and genetic codes, outcomes, consequences, sequelae and related variables and any combinations thereof, said sequences and algorithms referencing places, time, chronologies and having outcomes of statistical analyses.

8. The system according to claim 1 wherein said prognostications and foretells are sequences and algorithms of future chronicles comprising documents, documentaries, Web pages, Websites, digital presentations, videos, movies, voice data, phone conversations, tweets, email, compilations of digital contents and any combinations thereof.

9. The system according to claim 1 wherein said trends comprising prognostications and foretells and sequences and algorithms of prognostications and foretells in future and destinies.

10. The system according to claim 1 wherein said trends are streaming trends and static trends in the viewing screens including touchscreens of said networked servers and devices, said trends are adaptable, changeable and adjustable and altered or replaced in said system consequent to input instances being generated in said networks.

11. In a system for molding and controlling individuals' and people's future and destinies through networks of servers and devices, said system having system intellection and foresight for generating, maintaining, monitoring and adapting trends for molding said future and destinies based on system intellection and foresight processing input instances in conjunction with past and current chronicles possessing inherent abstracts, concepts, logics, meanings and implications in individuals' lives with relational data comprising past, current and future chronicles possessing inherent abstracts, concepts, logics, meanings and implications in individuals' and people's lives, histories and civilizations, said system intellection and foresight for generating, maintaining, monitoring and adapting trends for molding and controlling said future and destinies in said networks, a method for molding and controlling said future and destinies through networks based on a mechanism for said input instances in conjunction with past and current chronicles defining, system intellection and foresight selecting and servers disseminating said past, current and future chronicles for molding and controlling said future and destinies through said networks, said method comprising processes for:
networking said servers including virtual servers located in world-wide data centers and said devices comprising desktops, computer tablets, mobile communication devices and teleconferencing platforms henceforth devices, said networked serves and devices having networking capabilities including technologies for streaming, pushing, pulling and sharing data and trends among networked servers and devices;
creating said system intellection and foresight in said servers by coupling innovative computer program and software to servers processor units and coupling servers processor units to system storage including cloud-based storage and storing Big Data in said system storage, coupling to said system intellection and foresight at least one enterprise search technology, at least one Web search technology, data analytics and statistics analytics and at least one commercial technology for enhancing said system intellection and foresight in processing input instances with said relational data, searched relational data and inherent abstracts, concepts, logics, meanings and implications to generate trends;
coupling said system intellection and foresight to system storage, said system intellection and foresight to process input instances generated in said networks; said system intellection and foresight to apply input instances to generate, maintain, expand and adapt said relational data and inherent abstracts, concepts, logics, meanings and implications in said Big Data, said system intellection and foresight to expand and improve said relational data having inherent abstracts, concepts, logics, meanings and implications in individuals' and people's lives, histories and civilizations in Big data whenever input instances are processed by said system intellection and foresight, said system intellection and foresight to apply data analytics and statistics analytics to process input instances in conjunction with past and current chronicles in individuals' lives with relational data in said Big Data and searched relational data to generate inferences, decisions, determinations and conclusions attaching outcomes of statistical analyses, system intellection and foresight to generate, monitor, adjust and adapt and alter or replace trends in said system whenever processed input instances are relational elements in sequences and algorithms of past, current and future chronicles having acceptable degrees of statistical matches or fits in said searched relational data, said sequences and algorithms of past, current and future chronicles for generating trends, said system intellection and foresight to merge processed input instances and related sequences and algorithms of past, current and future chronicles with said relational data;
said networked devices to generate and submit input instances to said system intellection and foresight in networked servers, said input instances to define said relational data and inherent abstracts, concepts, logics, meanings and implications in said Big Data, said input instances to define said searched relational data having inherent abstracts, concepts, logics, meanings and implications, said input instances to define trends having outcomes of statistical analyses, said input instances to specify to said system intellection and foresight how to select searched relational data from relational data;
said input instances to cause said system intellection and foresight to generate, maintain and adapt or alter trends in and among said networked servers and devices;
said system intellection and foresight to generate, expand and improve explicit relations in said relational data, implicit relations of said relations, analogies of said relations, extrapolations and permutation of said relations and related logics, logical implications, deductions, inferences, determinations and conclusions having attached outcomes of statistical analyses, said relational data and relations possessing past, present and future chronicles having inherent abstracts, concepts, logics, meanings and implications, deductions, inferences, determinations, conclusions, knowledge, experiences, lessons in individuals' and people's lives, histories and civilizations in compilations in said Big Data based on said system intellection and foresight receiving and processing input instances;
said system intellection and foresight to apply search technologies, data analytics and statistics analytics to process input instances with relational data, searched relational data and searched World Wide Web data to generate, adjust, adapt, alter and/or replace trends in said networks whenever said input instances are generated and inputted into said servers in said networks; and
said networking capabilities to disseminate, stream, push, pull and share said trends among networked servers, individual devices and groups of devices in said networks.

12. The method according to claim 11 wherein said past, current and future chronicles in individuals' and people's lives, histories and civilizations comprise sequences and algorithms of causalities, causes, milestones, events, occurrences, processes, properties, facts, genotypes, phenotypes, genetics and genetic codes, consequences, sequelae and/or variables and any combinations thereof relating to places, time and chronologies possessing inherent abstracts, concepts, logics, meanings and implications, deductions, inferences, determinations and conclusions.

13. The method according to claim 11 wherein said input instances comprise causalities, causes, milestones, events, occurrences, processes, properties, facts, genotypes, phenotypes, genetics and genetic codes, consequences, sequelae, places, time, chronologies and/or variables and any combinations thereof having inherent abstracts, concepts, logics, meanings and implications, said input instances are generated by said networked devices.

14. The method according to claim 11 wherein said trends comprising prognostications and foretells and sequences and algorithms of prognostications and foretells of future and destinies.

15. The method according to claim 11 wherein said prognostications and foretells comprising sequences and algorithms of future chronicles comprising sequences and algorithms causalities, milestones, events, occurrences, processes, properties, facts, matters, genotypes, phenotypes, genetics and genetic codes, outcomes, consequences, sequelae and related variables and any combinations thereof, said sequences and algorithms referencing places, time, chronologies and having outcomes of statistical analyses.

16. The method according to claim 11 wherein said prognostications and foretells comprising sequences and algorithms of future chronicles comprising documents, documentaries, Web pages, websites, digital presentations, videos, movies, voice data, phone conversations, tweets, email, satellite images, compilations of digital contents and any combinations thereof.

17. The method according to claim 11 wherein said system intellection and foresight to apply search technologies, data analytics and statistics analytics to process input instances with relational data, searched relational data and searched World Wide Web data to generate, adjust, adapt, alter and/or replace trends in said networks comprises processes for said system intellection and foresight to:
analyze the inherent abstracts, concepts, logics, meanings and implications in sequences of data in said input instances and attached past and current chronicles;
analyze said sequences of data in said input instances and attached past and current chronicles;
specify and instruct said enterprise search technology to search said relational data in said Big Data for same, similar or analogous relations of abstracts, concepts, logics, meanings and/or implications and related same, similar or analogous relations comprising past, current and future chronicles in individuals' and people's lives, histories and civilizations in said relational data as same, similar or analogous sequences or algorithms of said abstracts, concepts, logics, meanings and implications in sequences of data in said input instances and past and current chronicles in individuals' lives;
specify and instruct said enterprise search technology to search said relational data in said Big Data for same, similar or analogous relations of past, current and future chronicles in individuals' and people's lives, histories and civilizations in said relational data as same, similar or analogous past and current chronicles in sequences or algorithms attaching to said input instances, said past and current chronicles and sequences of data in said input instances and said past, current and future chronicles in said relational data having same, similar or analogous abstracts, concepts, logics, meanings and/or implications; specify and instruct said enterprise search technology to search implicit relations of said relations and related logics, implications, deductions and inferences; analogies of said relations and related logics, implications, deductions and inferences, permutations in and among said explicit, implicit relations and analogies and related logics, implications, deductions and inferences; extrapolations of said relations and permutations and related logics, implications, deductions and inferences, and said relations and extrapolations and permutation of said relations and related abstracts, concepts, logics, meanings and implications, deductions, inferences, determinations and conclusions;
apply statistics analytics to said searched relations to determine good degrees of statistical matches or fits and, accordingly, said system intellection and foresight to select said past, current and future chronicles to generate trends comprising sequences or algorithms of said past, current and future chronicles representing system intellection and foresight-generated prognostications and foretells and sequences and algorithms of prognostications and foretells of individuals' future and destinies;
specify and instruct said web search technology to search World Wide Web data to complement said searched relations if outcomes of said statistics analyses produced unacceptable or not good statistical matches or fits and to repeat said processes;
generate queries to networked devices to generate additional input instances to if outcomes of said data analyses and statistics analyses produced unacceptable statistical matches or fits and to repeat said processes;
generate requests to networked devices to generate additional input instances to if outcomes of said data analyses and statistics analyses produced unacceptable statistical matches or fits and to repeat said processes; and
system network capabilities to disseminate, stream and share said trends including adaptations, changes and adjustments or alterations or replacements of trends having attached outcomes of statistical analyses among networked servers and devices.

18. In a system for molding and controlling individuals' and people's future and destinies through networks of servers and devices, said system having system intellection and foresight for generating, maintaining, monitoring and adapting trends for molding said future and destinies based on system intellection and foresight processing input instances in conjunction with past and current chronicles possessing inherent abstracts, concepts, logics, meanings and implications in individuals' lives with relational data comprising past, current and future chronicles possessing inherent abstracts, concepts, logics, meanings and implications in individuals' and people's lives, histories and civilizations, said system intellection and foresight for generating, maintaining, monitoring and adapting trends for molding and controlling said future and destinies in said networks, a method for generating and disseminating prognostications and foretells and sequences and algorithms of prognostications and foretells of said future and destinies through said networks based on said system intellection and foresight processing said input instances in conjunction with past and current chronicles possessing inherent abstracts, concepts, logics, meanings and implications with searched relational data to generate and said servers to disseminate trends in said networks, said trends to mold and control said future and destinies, said method comprising processes for:
networking said servers including virtual servers located in world-wide data centers and said devices comprising desktops, computer tablets, mobile communication devices and teleconferencing platforms henceforth devices, said networked serves and devices having networking capabilities including technologies for streaming, pushing, pulling and sharing data and trends among networked servers and devices;
creating said system intellection and foresight in said servers by coupling innovative computer program and software to servers processor units and coupling servers processor units to system storage including cloud-based storage and storing Big Data in said system storage, coupling to said system intellection and foresight at least one enterprise search technology, at least one Web search technology, data analytics and statistics analytics and at least one commercial technology for enhancing said system intellection and foresight in processing input instances with said relational data, searched relational data and inherent abstracts, concepts, logics, meanings and implications to generate trends;
coupling said system intellection and foresight to system storage, said system intellection and foresight to process input instances generated in said networks; said system intellection and foresight to apply input instances to generate, maintain, expand and adapt said relational data and inherent abstracts, concepts, logics, meanings and implications in said Big Data, said system intellection and foresight to expand and improve said relational data having inherent abstracts, concepts, logics, meanings and implications in individuals' and people's lives, histories and civilizations in Big data whenever input instances are processed by said system intellection and foresight, said system intellection and foresight to apply data analytics and statistics analytics to process input instances in conjunction with past and current chronicles in individuals' lives with relational data in said Big Data and searched relational data to generate inferences, decisions, determinations and conclusions attaching outcomes of statistical analyses, system intellection and foresight to generate, monitor, adjust and adapt and alter or replace trends in said system whenever processed input instances are relational elements in sequences and algorithms of past, current and future chronicles having acceptable degrees of statistical matches or fits in said searched relational data, said sequences and algorithms of past, current and future chronicles for generating trends, said system intellection and foresight to merge processed input instances and related sequences and algorithms of past, current and future chronicles with said relational data;
said networked devices to generate and submit input instances to said system intellection and foresight in networked servers, said input instances to define said relational data and inherent abstracts, concepts, logics, meanings and implications in said Big Data, said input instances to define said searched relational data having inherent abstracts, concepts, logics, meanings and implications, said input instances to define trends having outcomes of statistical analyses, said input instances to specify to said system intellection and foresight how to select searched relational data from relational data;
said input instances to cause said system intellection and foresight to generate, maintain and adapt or alter trends in and among said networked servers and devices;
said system intellection and foresight to generate, expand and improve explicit relations in said relational data, implicit relations of said relations, analogies of said relations, extrapolations and permutation of said relations and related logics, logical implications, deductions, inferences, determinations and conclusions having attached outcomes of statistical analyses, said relational data and relations possessing past, present and future chronicles having inherent abstracts, concepts, logics, meanings and implications, deductions, inferences, determinations, conclusions, knowledge, experiences, lessons in individuals' and people's lives, histories and civilizations in compilations in said Big Data based on said system intellection and foresight receiving and processing input instances;
said system intellection and foresight to apply search technologies, data analytics and statistics analytics to process input instances with relational data, searched relational data and searched World Wide Web data to generate, adjust, adapt, alter and/or replace trends in said networks whenever said input instances are generated and inputted into said servers in said networks; and
said networking capabilities to disseminate, stream, push, pull and share said trends among networked servers, individual devices and groups of devices in said networks.

19. The method according to claim 18 wherein said past, current and future chronicles in individuals' and people's lives, histories and civilizations comprise sequences and algorithms of causalities, causes, milestones, events, occurrences, processes, properties, facts, genotypes, phenotypes, genetics and genetic codes, consequences, sequelae and/or variables and any combinations thereof relating to places, time and chronologies possessing inherent abstracts, concepts, logics, meanings and implications, deductions, inferences, determinations and conclusions.

20. The method according to claim 18 wherein said system intellection and foresight to apply search technologies, data analytics and statistics analytics to process input instances with relational data, searched relational data and searched World Wide Web data to generate, adjust, adapt, alter and/or replace trends in said networks comprises processes for said system intellection and foresight to:
analyze the inherent abstracts, concepts, logics, meanings and implications in sequences of data in said input instances and attached past and current chronicles;
analyze said sequences of data in said input instances and attached past and current chronicles;
specify and instruct said enterprise search technology to search said relational data in said Big Data for same, similar or analogous relations of abstracts, concepts, logics, meanings and/or implications and related same, similar or analogous relations comprising past, current and future chronicles in individuals' and people's lives, histories and civilizations in said relational data as same, similar or analogous sequences or algorithms of said abstracts, concepts, logics, meanings and implications in sequences of data in said input instances and past and current chronicles in individuals' lives;
specify and instruct said enterprise search technology to search said relational data in said Big Data for same, similar or analogous relations of past, current and future chronicles in individuals' and people's lives, histories and civilizations in said relational data as same, similar or analogous past and current chronicles in sequences or algorithms attaching to said input instances, said past and current chronicles and sequences of data in said input instances and said past, current and future chronicles in said relational data having same, similar or analogous abstracts, concepts, logics, meanings and/or implications;
specify and instruct said enterprise search technology to search implicit relations of said relations and related logics, implications, deductions and inferences; analogies of said relations and related logics, implications, deductions and inferences, permutations in and among said explicit, implicit relations and analogies and related logics, implications, deductions and inferences; extrapolations of said relations and permutations and related logics, implications, deductions and inferences, and said relations and extrapolations and permutation of said relations and related abstracts, concepts, logics, meanings and implications, deductions, inferences, determinations and conclusions;
apply statistics analytics to said searched relations to determine good degrees of statistical matches or fits and, accordingly, said system intellection and foresight to select said past, current and future chronicles to generate trends comprising sequences or algorithms of said past, current and future chronicles representing system intellection and foresight-generated prognostications and foretells and sequences and algorithms of prognostications and foretells of individuals' future and destinies;
specify and instruct said web search technology to search World Wide Web data to complement said searched relations if outcomes of said statistics analyses produced unacceptable or not good statistical matches or fits and to repeat said processes;
generate queries to networked devices to generate additional input instances to if outcomes of said data analyses and statistics analyses produced unacceptable statistical matches or fits and to repeat said processes;
generate requests to networked devices to generate additional input instances to if outcomes of said data analyses and statistics analyses produced unacceptable statistical matches or fits and to repeat said processes; and
system network capabilities to disseminate, stream and share said trends including adaptations, changes and adjustments or alterations or replacements of trends having attached outcomes of statistical analyses among networked servers and devices.
